(19) United States
(12) Patent Application Publication
(10) Pub. No.: US 2024/0420035 A1
(43) Pub. Date: Dec. 19, 2024

(54) VENUE MANAGEMENT SYSTEM FOR DURING EVENT TRANSACTIONS

(71) Applicant: UPCLOSE, LLC, New York, NY (US)

(72) Inventors: Jeffrey W. STIER, New York, NY (US); Michael J. STIER, New York, NY (US); Adam BLOCK, New York, NY (US)

(73) Assignee: UPCLOSE, LLC, New York, NY (US)

(21) Appl. No.: 18/745,931

(22) Filed: Jun. 17, 2024

Related U.S. Application Data
(60) Provisional application No. 63/521,596, filed on Jun. 16, 2023.

(51) Int. Cl. G06Q 10/02; G06Q 20/22; G06Q 30/08

(52) U.S. Cl. CPC G06Q 10/02; G06Q 20/223; G06Q 30/08

(57) ABSTRACT

An electronic ticket processing system that includes the management of a venue with auction-based, during event, peer-to-peer electronic ticket exchanges. The peer-to-peer during event ticket exchange may be limited by the location of the electronic device of a user and may allow the event attendees enhancement of their experience (e.g. by upgrading their seat location or rights to access). In some embodiments, the during event peer-to-peer ticket exchange may be encouraged or controlled by the venue based on certain factors, such as, broadcasting considerations, crowd control, analytics, to encourage consumer spending, memberships, and/or other real time updates (e.g., weather, game scores, security concerns).

### CROSS REFERENCE TO RELATED APPLICATIONS

This application claims priority to and the benefit of U.S. Provisional Patent Application No. 63/521,596 filed Jun. 16, 2023. The foregoing provisional application is incorporated by reference herein in its entirety.

### GENERAL DESCRIPTION

Venues for hosting ticked events have adopted electronic ticketing for the sale and distribution of event admission tickets. There are electronic ticketing systems that enable customers to purchase admission tickets prior to an event. In certain pre-event sale systems, codes are employed to provide buyers with exclusive access to better seating locations and/or blocked seating areas in accordance with a membership. Further, prior to the event, in certain systems a ticket buyer has the ability to resell a verified ticket to another buyer through an electronic ticket listing agent. Certain vendors also provide services that search through electronic ticket listing agents and compare pricing. However, none of these systems provide a seller with the ability to control a sale of a ticket during an event, or a means for a seller to create and benefit from a real-time, during-event auction for their ticket, or for the seller and buyer to directly negotiate a purchase price for a ticket without the presence or participation of an intermediary ticket listing agent.

Certain wireless device technology and ticketing applications currently provide ticket holders who have purchased a ticket prior to the event with additional options and functionality for improved venue experiences. For example, U.S. Pat. No. 10,187,609 describes a wireless system used to distribute video content during sporting events in stadiums, arenas, and similar venues using wireless access points. U.S. Patent Application Publication No. 2013/0096961 A1 describes a system that is said to ensure authenticity of a ticket and may eliminate the need to print a ticket to eliminate logistical constraints of venue ticket upgrading/downgrading a ticket during an event. Also, to enhance venue access experience, U.S. Patent Application Publication No. 2016/0189545 A1 describes systems to manage parking lots around venues in a manner that accounts for current traffic conditions. U.S. Pat. No. 9,798,984 describes systems that use knowledge about social media contacts of the ticket holder to generate dynamic pre-event ticket offers, recommendations, or orders, based on that ticket holder's information and to manage and order from a venue's concession stands.

While all of these developments are directed towards providing a ticket holder with a better overall event experience, the current systems fall short of improving what is arguably the most important factor in optimizing the in-venue ticket holder experience: the location of the seat relative to the event taking place in the venue, and the seat's ability to provide an exceptional line-of-sight for viewing the event taking place in the venue.

For example, none of the previously mentioned systems provide a means for a ticket holder (who has purchased a ticket prior to the event and subsequently enters the venue) to once the event has started, purchase a new ticket in the same venue that offers them an improved experience via a seat that is closer to the event or has a better line-of-sight.

Also, none of these systems provide the venue, or any party that may hold unsold tickets at the start of an event, to make those unsold tickets available after the start of the event to ticket holders who are either already in the venue, or are close enough to the venue, as determined by geo-fencing, to get to the event in a reasonable amount of time to enjoy the event.

Many shortcomings of existing systems and processes fail to fully optimize the ticket holders during-event experience. Accordingly, improved processes and systems are desired.

For example, there is a need for an improved electronic ticket exchange and transaction process and system that may enable more effective venue management based on improving event attendees' pre-event, during-event and post-event experiences.

There is a need for an improved electronic ticket exchange and transaction process and system that may enable more effective venue management of any unsold seat inventory that exists at the start of the event such that the venue can generate revenue from those unsold seats by making them available for sale in order to improve event attendees' pre-event, during-event and post-event experiences.

There is also a need for an electronic ticket exchange and transaction process and system that may enable the venue and other various involved parties to increase their revenue, in the form or royalties or fees from ticket sales, as a direct result of increased during-event, ticket exchanges and transactions—which maybe be from peer-to-peer negotiations, or real time auctions, both of which eliminate the need for a ticket agent to facilitate or participate in the transaction.

There is also a need for an electronic ticket exchange and transaction process and system that may enable the venue and other various involved parties to increase their revenue by creating a peer-to-peer market place for real-time ticket auctions and seller-buyer negotiations that eliminate the need for ticket agents and, therefore, also eliminate the obligation of the venues to pay ticket agents a fee or royalty for their services.

There is a need for an electronic ticket exchange and transaction process and system that may play a role in optimizing the during-event experience of a ticket buyer or seller by enabling the expansion of the experience from the physical venue to a surrounding area that is pre-defined by geo-fencing.

There is a need for an electronic ticket exchange and transaction process and system that may enable further improved experiences based on user programs such as rewards, groups, or memberships.

There is a need for an electronic ticket exchange and transaction process and system that may optimize the during-event experience of a ticket buyer or seller by generating for the seller and/or buyer a benefit such as psychological goodwill or a tax deduction, due to the donation of a portion of the revenue from the during-event sale or purchase of a ticket to a charity or other philanthropic organization.

There is a need for an electronic ticket exchange and transaction process and system that may use proprietary algorithms to suggest a starting price for either a peer-to-peer negotiation or a seller to buyers auction, by using real-time data that includes but is not limited to weather; time remaining in an event; score or standings if a sporting event; and more.

There is a need for an electronic ticket exchange and transaction process and system that may effectively expand admission acquisition times for an event.

There is a need for an electronic ticket exchange and transaction process and system that may incorporate geosocial phenomena as part of electronic ticket exchange transactions.

Accordingly, improved solutions for electronic ticket systems and processes that may be practically implemented and overcome the aforementioned needs are desired.

### SUMMARY

The foregoing needs are met, to a great extent, by the disclosed embodiments, which are intended to address one or more fundamental opportunities to improve and advance existing ticket exchange and venue management solutions. The improved venue management system, for example, by overcoming existing drawbacks and expanding physical barriers of a venue to enable a peer-to-peer ticket exchange after the start of an event while helping manage a venue's seating/access in a practical way.

According to some aspects of the disclosure, a computing device for the management of a venue is disclosed. The computing device may include: communication with a plurality of wireless devices; communication with a venue's seat inventory system; and executable software code for transmitting an event beginning and ending time data, transmitting the event location data and a pre-determined geofenced location area, and processing a seat exchange at a time in between the transmitted beginning and ending time data. In accordance with some aspects, the seat exchange may include a verification including transmitting a location of one or more of the plurality of wireless devices and confirming that the location of the one or more of the plurality of wireless devices is within the pre-determined geofenced location area.

In some embodiments, the seat exchange additionally comprises at least one of a ticket verification and a membership verification. The verification may also include a location of one or more of the plurality of smart phone devices, e.g., as it may be determined by a local area network and/or the global positioning system of one of the plurality of the smart phone devices. For devices outside of the pre-determined geofences area/location range, a view mode only to the seat inventory may be implemented. Wireless devices may include smartphone devices, tablets, smart wearable devices, laptops, and the like.

In accordance with additional aspects of the disclosure, a suggested value for the seat exchange by determining an event's remaining time for the event using the beginning and ending time data may be determined. In some embodiments, the determination may also include a live event update that is received in real time, such as, weather data, a broadcasting camera's location, an event's feedback or score, attendance data, crowd distribution, safety or evacuation procedures, and a news update or any other geosocial phenomena.

In accordance with yet additional aspects of the disclosure, a method for managing a venue is disclosed. The method including: maintaining a venue's seat inventory system for an event; transmitting an event beginning and ending time; transmitting the event location; processing a seat exchange between the beginning and ending time data; verifying a location of one or more a plurality of smart phone devices, and verifying that the location of the one or more of the plurality of smart phone devices is within a pre-determined distance from the event location data. In accordance with some aspects, attendance to an event may be increased by enabling after start of event ticket exchange by a user/venue. In some applications, for example, one seat during an event may be sold several times by the venue for one or more portions of the event.

In accordance with yet additional aspects of the disclosure, the method may also include: maintaining a venue's seat inventory system for an event; transmitting an event's beginning and ending time; transmitting the event location; receiving a location of one or more a plurality of smart phone devices; verifying that the location of the one or more of the plurality of smart phone devices is within a location range; displaying a suggested value determined using one or more of a weather data, a broadcasting camera's location, an event's feedback or score, attendance data, and a news update; and transferring a seat or access to an event's attendee.

A more detailed explanation of the disclosed embodiments are provided in the following detailed descriptions and appended claims taken in conjunction with the accompanying drawings.

### BRIEF DESCRIPTION OF THE DRAWINGS

The accompanying drawings, which are included to provide a further understanding of the disclosed embodiments, are incorporated in and constitute a part of this specification, and together with the detailed description serve to explain the principles of the invention. Reference will now be made to the accompanying drawings. Like reference numerals may indicate corresponding parts in various drawings.

FIG. 1 illustrates an exemplary location-based network environment for during event peer-to-peer ticket exchange.

FIG. 2 is a flow diagram including exemplary method steps for during event venue electronic ticket processing.

FIG. 3 illustrates a block diagram of a processor apparatus that may be used to implement various aspects of the disclosed embodiments.

FIG. 4 is a flow diagram including exemplary method steps that may take place during event venue electronic ticket processing according to additional membership aspects of the disclosed embodiments.

FIG. 5 is a flow diagram including exemplary method steps that may take place during event venue electronic ticket processing according to additional venue management aspects of the disclosed embodiments.

FIG. 6 is a flow diagram including exemplary method steps that may take place during event venue electronic ticket processing according to various disclosed embodiments of a peer-to-peer ticket exchange.

FIGS. 7A-7L illustrate exemplary user interface displays for a peer-to-peer ticket exchange during event in accordance with aspects of the disclosed embodiments; and

FIGS. 8A-8H illustrate exemplary user interface displays for a peer-to-peer ticket purchase or exchange during the event in accordance with various aspects of the disclosed embodiments.

FIG. 9 is a flow diagram including exemplary method steps that may take place during the processing of a during event ticket exchange according to the various embodiments of a peer-to-peer ticket exchange disclosed herein.

FIG. 10 is a flow diagram including exemplary method steps that may take place during the processing of a during event ticket exchange according to the various embodiments of a peer-to-peer ticket exchange disclosed herein.

The disclosed embodiments and examples are further described in the detailed description that follows.

### DETAILED DESCRIPTION

Various components of the venue management system and process for during event peer-to-peer ticket exchange may described as in communication, or part of a network, or are coupled, attached, and/or joined together. As used herein, the terms “connected”, “in communication”, “coupled”, “attached”, and/or “joined” are used to indicate either a direct connection between two components or, where appropriate, an indirect connection to one another through intervening or intermediate components. In contrast, when a component is referred to as being “directly connected”, “directly attached”, and/or “directly joined” to another component, there are no intervening elements present.

Various aspects of the venue management system and process may be illustrated with reference to one or more exemplary embodiments. As used herein, the term “exemplary” means “serving as an example, instance, or illustration,” and should not necessarily be construed as preferred or advantageous over other embodiments of the venue management system and processes disclosed herein.

In this description and claims directed to the disclosure, various terms may be used for which the following definitions will apply:

“Dynamic acceptable range” as used herein may refer to a subscribing partner's location range which decreases proportionally to the event's remaining time. For example, an acceptable range may be 2 miles when there is an hour remaining of the event's time and 0.5 miles when there is 30 minutes left of event time.

“Event location data” as used herein may refer to geographical positioning system coordinates, or one or more registered local area network(s).

“Geofenced electronic ticket exchange” as used herein refers to a location-based electronic ticket exchange using GPS, RFID, a local area network, or cellular data to trigger the pre-programmed electronic ticket exchange when a wireless device enters a virtual boundary (e.g. network range) set up around a geographic location or location range. More particularly, the virtual boundary which may be at sections inside the venue, a perimeter around the venue, and/or location subscribing partners within a certain proximity from the venue. Subscribing partners may include restaurants, bars, or any other pre-approved location subscriber that is within a dynamic acceptable range.

The determination of whether or not electronic devices are within the Geofenced area may include determining the strength of the network signal to the wireless device of the location. For example, the wireless device of interest may have to have a specific strength of decibel (dBm) to the network in order to be determined that the wireless device is within the geofenced area. In one embodiment, determinization of whether or not the wireless device is within the geofenced area may utilize calculating an absolute position of the wireless device via a GPS signals. Specifically, analyzing an absolute time of reception of the GPS signals from a plurality of satellites, and calculating the absolute position depending on the absolute time of reception of each GPS signal from the corresponding plurality of satellites, and then comparing the absolute position of the electronic device to a geographic location by calculating the distance of the calculated absolute position to the geographic location. In another embodiment, confirming whether or not electronic devices are within the Geofenced area includes whether or not the electronic device GPS coordinates overlap with the coordinates associated with the event.

“Membership”, “group”, or “rewards program” as used herein may refer to an entitlement to an additional seat exchange related benefit or participation in a seat exchange program itself. For example, the membership or rewards program may be one of a bank, such as, a credit card, and a group may be a classification, such as, students, first responders, or military.

“Peer-to-peer transaction” generally refers to the electronic exchange of a seat or access inside a venue during an event that is between one or more of: at least two or more attendees, the venue seat management system, a rewards/membership program administrator, an event ticket retailer, or any other party(s) related to the event. In accordance with certain embodiments of the disclosure, the peer-to-peer transaction takes place during an event as opposed to before the event's start time.

“Party” or “parties” may relate to the buyer or seller of an electronic ticket. Sellers are, for example but not limited to, the venue, the participating teams, entities, or persons performing at the event, corporations, or any other holder of unsold ticket inventory to that event, an existing ticket holder, who may be an attendee at the event. Buyers are, for example but not limited to, existing ticket holder(s) and an attendee at the same event as the seller, existing ticket holder(s) to same event as the seller, and who is within a predetermined proximity to the event venue, non-ticket holder(s) who is within a predetermined proximity to the event venue.

“Seat exchange” as used herein refers to the purchase or redemption of a seat or private section access for a ticketed event with assigned seats or sections occurring after the start time of the event.

“Venue inventory” as used herein may refer to a seat or attendance inventory associated with an event.

According to at least one disclosed embodiment, an electronic ticket processing system is disclosed that uses an auction-based, dynamic bidding process to facilitate and manage a price negotiation between two parties in order to facilitate a during-event sale or resale of a ticket followed by the electronic transfer of the ticket (e.g. a transaction) between the two parties (i.e., the seller and the buyer). The ticket may be to a seat, a limited access location, or to a reward or other special consideration or access provided to the holder of the ticket.

The seller to buyer, during-event ticket sale and transaction, may be limited by the location of the electronic device of a user and in some embodiments, the during event peer-to-peer ticket exchange may be encouraged or controlled by the venue in accordance to broadcasting aspects, crowd control, analytics, to encourage consumer spending, memberships, and/or other real time updates (e.g. weather, game scores, security concerns, etc.).

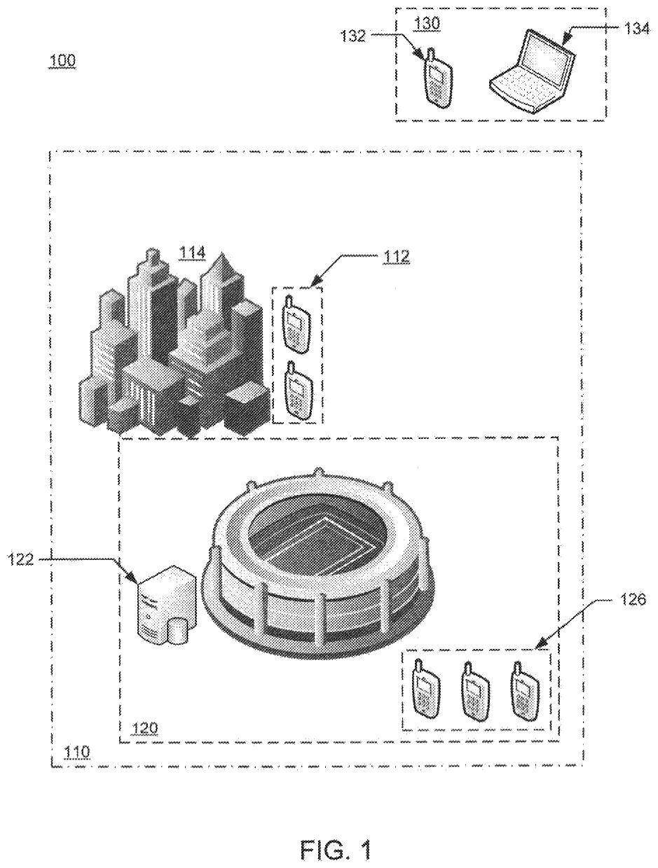

Referring now to FIG. 1, an exemplary location-based network environment 100 for during event peer-to-peer ticket exchange according to aspects of the disclosure is shown. The location-based network 100 including a dynamic acceptable range 110 which encompasses the venue 120 and subscribing partners 114. Within the dynamic acceptable range 110 and the venue 120, computing devices, such as, wireless devices 112 and 126 of users are included. In addition, a venue's computing device 122 may be included to process or manage access to the venue and distribution of attendees in the venue.

Outside the dynamic acceptable range 130 there may be wireless devices 132 and 134 of other users, for example, subscriber users that, may be able to access the application with read only functionality or sell only functionality for those users that were unable to attend the event and sell their ticket prior to start time in conventional electronic ticket exchange applications.

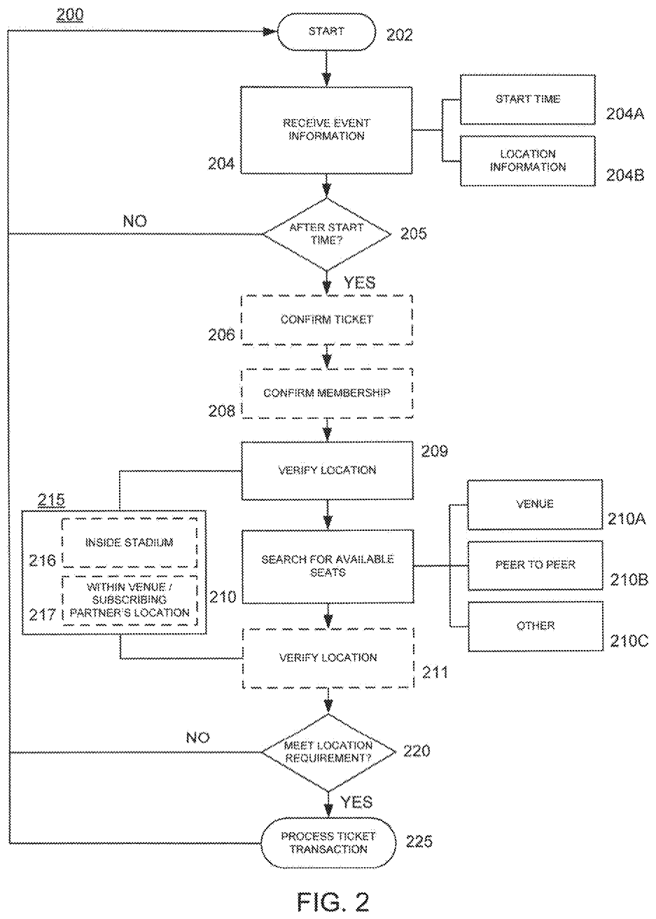

Referring now to FIG. 2, a flow diagram 200 including exemplary method steps for during event venue electronic ticket processing according to various aspects of the disclosure is shown. Beginning at 202, a user may visit a website or access a wireless device's application (“App”). At the web site/App, the user inputs event information for the system to receive the event information 204 and retrieve date and start time of the event 204A and location information 204B. Location information 204B is not limited to venue specific information, but may also include a dynamic acceptable range that includes subscribing partners.

At 205, the website/App's system will confirm that the event has begun. If before or after event's duration, the application will not be enabled, and the user will be instructed to return during event. When the system confirms that the event has started 205 and it is such that the user has already purchased a ticket for the event or is inside of the venue, optionally, at least one of a user's ticket 206 and a membership 208 may be confirmed. At 209, the location of the user may be verified by retrieving the wireless device's location information 215 in order to ensure the user is either inside of the stadium 216, or within venue perimeter or at a subscribing partner's location 217. In accordance with some aspects, the subscribing partner's location acceptability is dynamic and will vary depending on remaining event's duration.

At 210, a search for available seats/access is determined. Available seats/access may be those unsold by the venue 210A or another 210C, such as, those blocked by a rewards/membership offering entity. By way of non-limiting example, those rewards/membership offering entities may include event sponsors, stadium owners, and the like. In accordance with aspects of the disclosure, for a during event peer-to-peer transaction 210B, other available seats/access tickets may be those of other user attendees that are leaving early, never made it to the event, or they themselves bought an upgraded seat and their original seat becomes available. By enabling the re-selling of a ticket for a portion of the event (i.e. turning up each seat similarly to how a restaurant may be able to turn up tables during lunch/dinner hours), the venue and/or users are able to maximize attendance throughout the event. In addition, in some applications, users that change their seat location or leave the event may recover a portion of the ticket price paid.

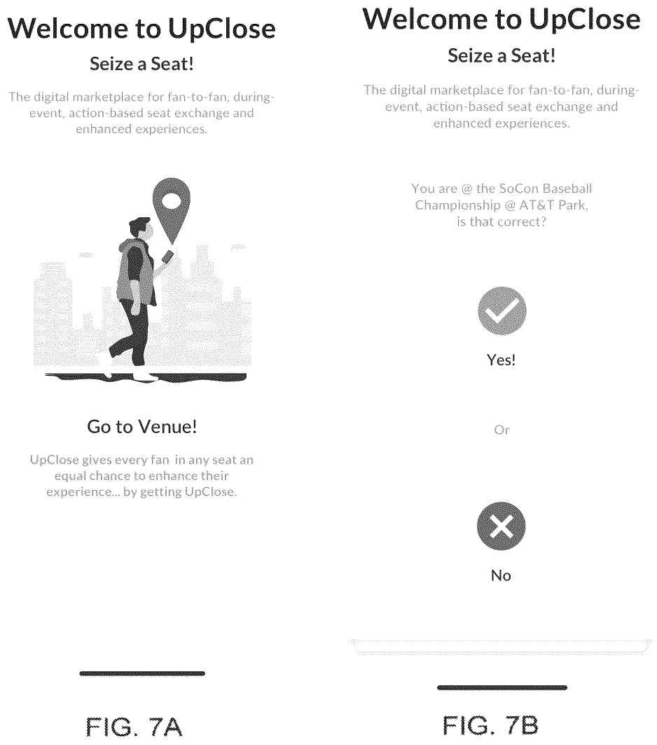

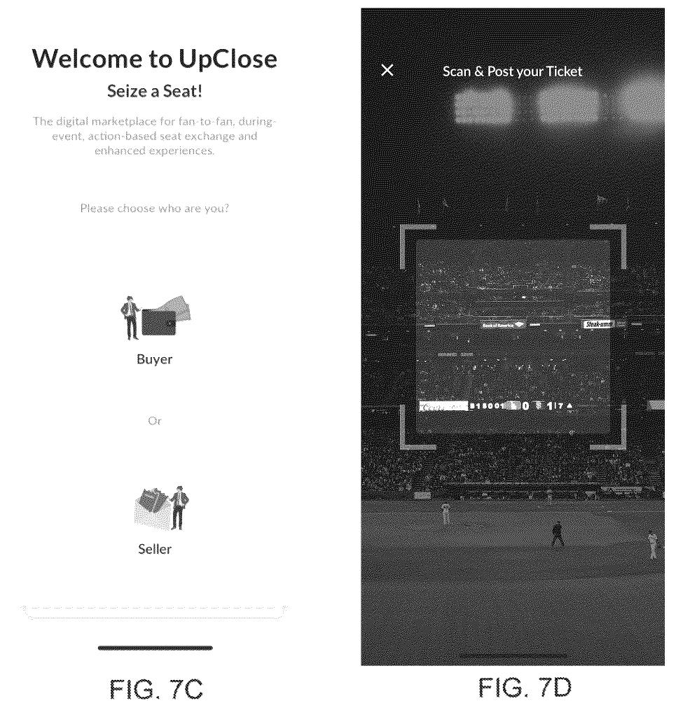

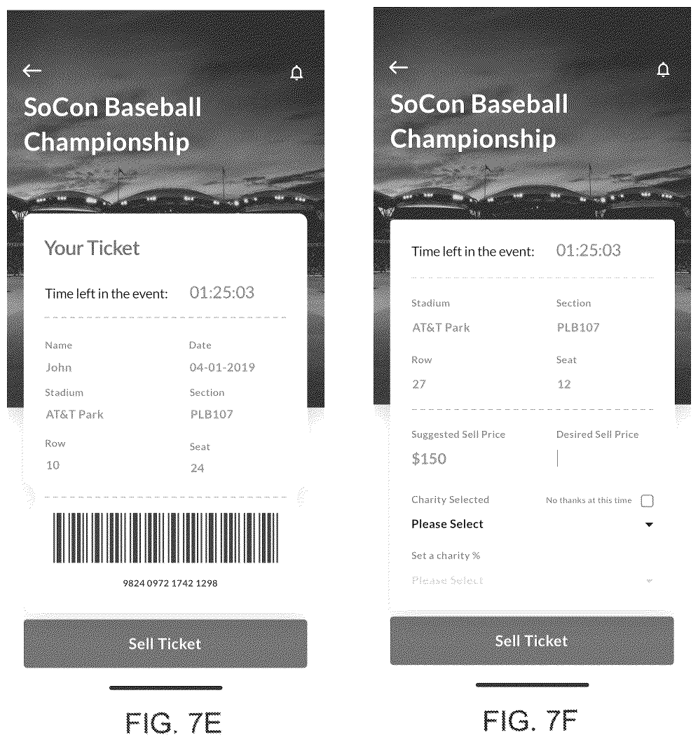

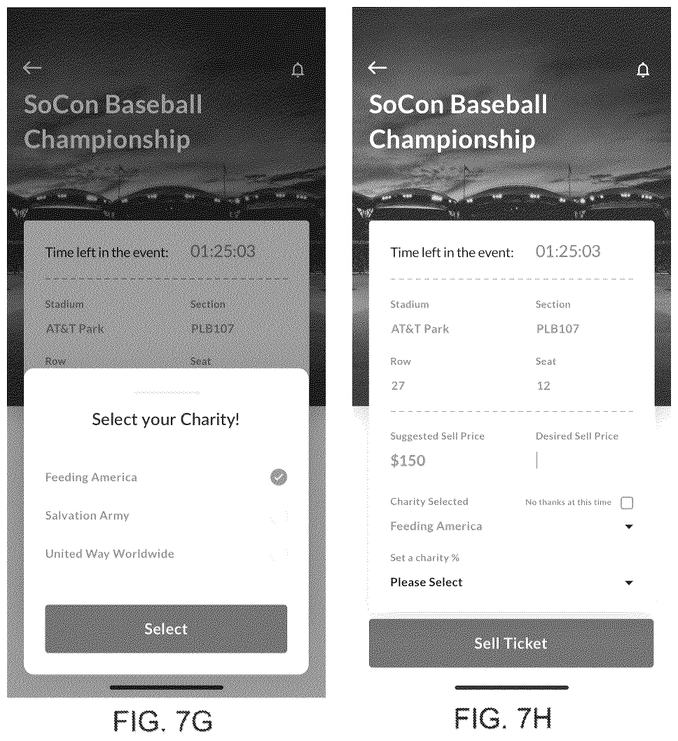

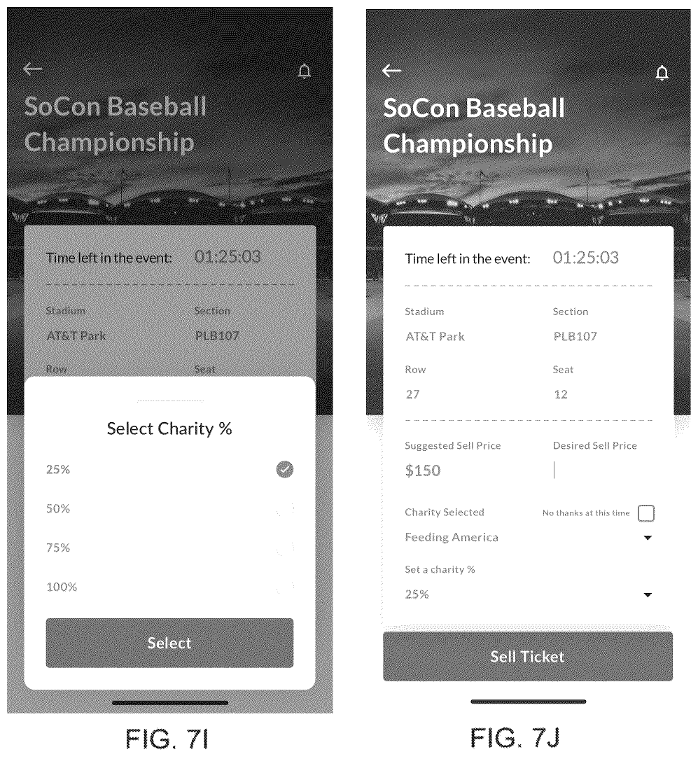

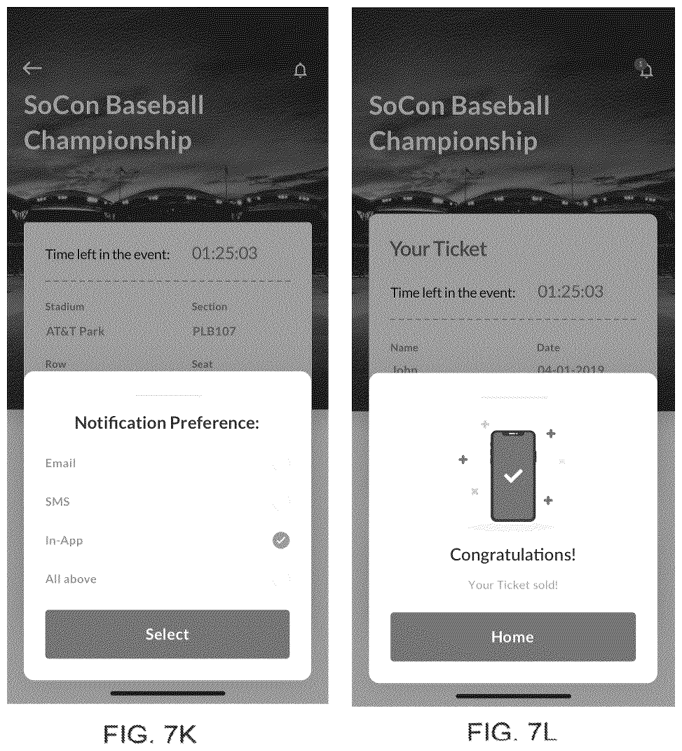

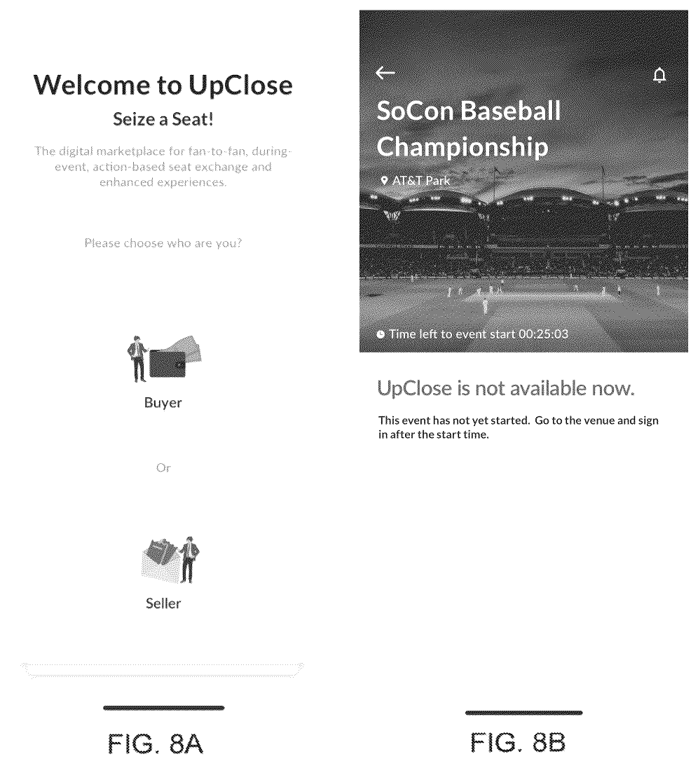

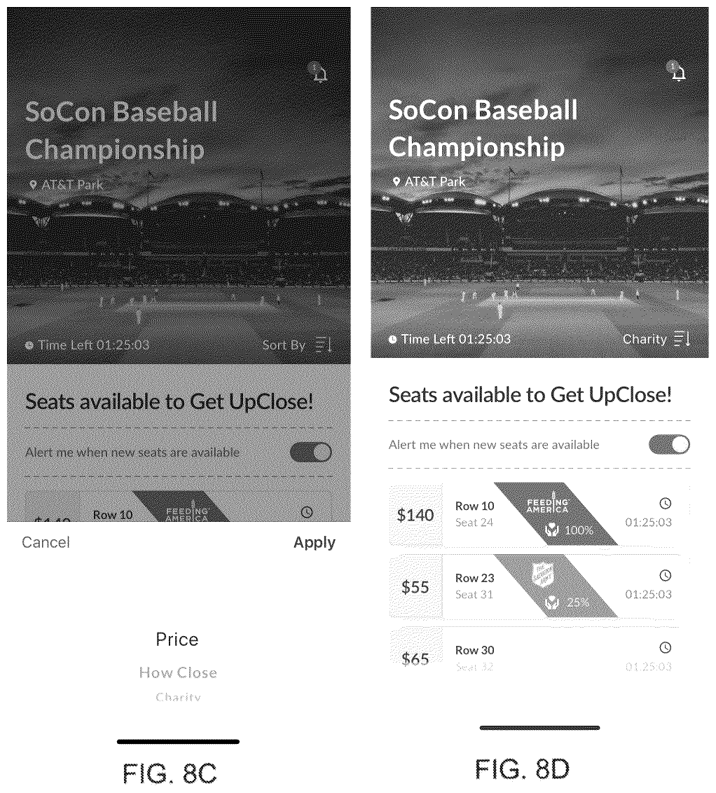

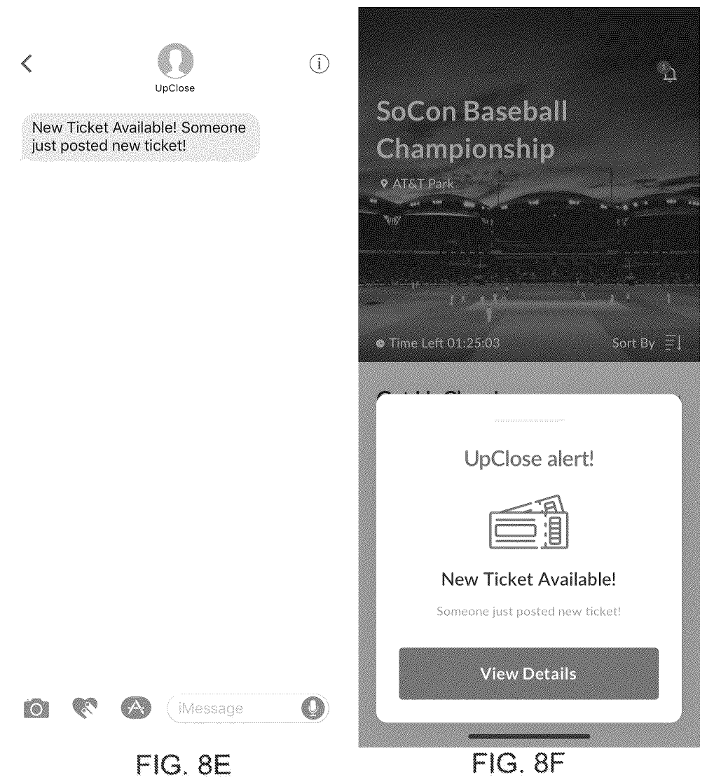

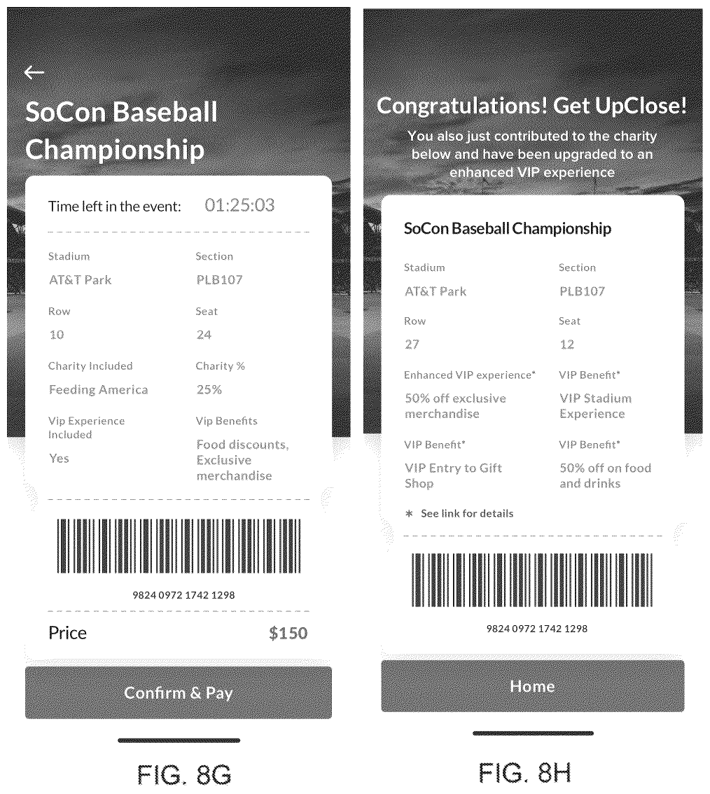

Optionally at 211, the location(s) of one or both the buyer of a ticket and the seller may be verified by transmitting wireless device location information. Once the location requirement is met at 220, at 225, the ticket electronic ticket transaction may be processed. Certain aspects of the electronic ticket transaction will be described as illustrated in FIGS. 7A-7L and 8A-8H.

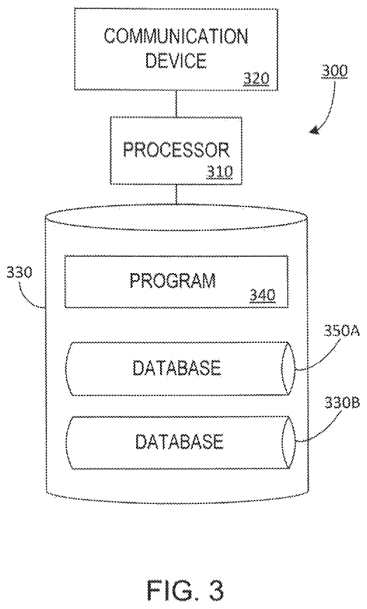

Referring now to FIG. 3, a block diagram of a processor venue management system that may be used to implement various aspects of the disclosure is shown. A controller 300 that may be embodied in one or more systems of the venue and/or website/App owner may be used to implement some embodiments of the present disclosure. The controller 300 comprises a processor unit 310, such as one or more processors, coupled to a communication device 320 configured to communicate via a communication network (e.g., as shown in FIG. 1). The communication device 320 may be used to communicate, for example, with two or more, Bluetooth or network devices, such as, personal computers, wireless devices, computers, automobile, or a smart handheld or wearable device.

The processor 310 may also be in communication with a storage device 330. The storage device 330 may comprise any appropriate information storage device, including combinations of electronic storage devices, such as, for example, one or more of: hard disk drive, optical or magnetic storage devices, and semiconductor memory devices such as Random Access Memory (RAM) devices and Rea Only Memory (ROM) devices. The storage device 330 may store a program 340 for controlling the processor 310. The processor 310 performs instructions of the program 340, and thereby operates in accordance with the aspects of the disclosure. The processor 310 may also cause the communication device 320 to transmit information, including, in some instances, control commands to operate the processes described herein. Some specific examples of apparatus utilized to implement various aspects of the disclosure may include a computer server, a personal computer, a laptop computer, a handheld computer, an iPad, a wireless device (e.g. smartphone), or other communication device, or any other processor and display equipped device.

The program 340 may additionally be in communication with databases 350A and/or 350B, and other external databases (not shown) through the communication device 320. Databases may include, for example, seat inventory, event's statistics, weather, traffic, social network data corresponding to the user, crowd control information for safety, broadcasting network's preferences, membership/rewards program/group verification data, and the like. In some embodiments, apparatus may be in communication with a video and data server farm. The video and data server farm may include at least one video/image representation associated with the venue and/or event. Transmission of such may be used by the venue to manage, encourage, or engage fan audience in accordance with certain aspects of the disclosure.

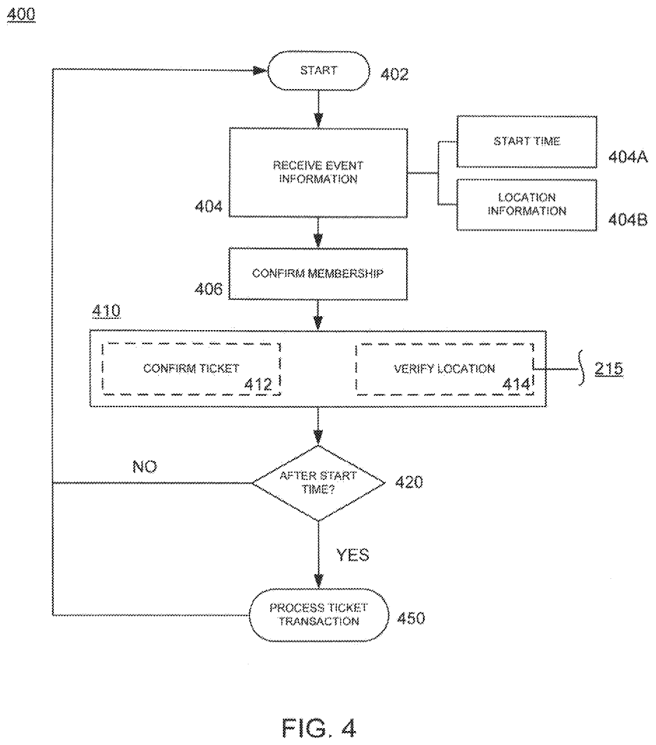

FIG. 4 depicts a flow diagram for an electronic ticket processing system 400. The system includes exemplary method steps that may take place during an event venue electronic ticket processing that includes considering whether or not a membership account of one of the users is implicated or initiated. Beginning at 402, event information 404 is transmitted 404 to confirm a start time 404A and location 404B of an event. The event may include, for example, a concert, sporting event, presentation, and the like. At 406, a rewards program, a membership, or a group, of user may be confirmed. By way of nonlimiting examples, a rewards program may be that of the electronic ticket exchange App itself, a credit card points program and the like. A membership may include, for example, a credit card, a sports club, a social club, and/or a bank. A group may include, for example, veterans, teachers, students, and similar groups which the venue/sponsor may want to offer special benefits to.

At 410, at least one of an existing ticket 412 and location 414 may be confirmed. For example, as described herein with reference to 215 in FIG. 2. The determination that the event has begun 420 here is also needed before the upgraded ticket may be processed 450. In some embodiments, the electronic ticket issued by the membership provider may be access to a VIP area or upgraded seat, subject to rewards points earned, or the like. For example, different seats or VIP areas may be available to those that have used the App a number of times to upgrade their tickets, earning redeemable points.

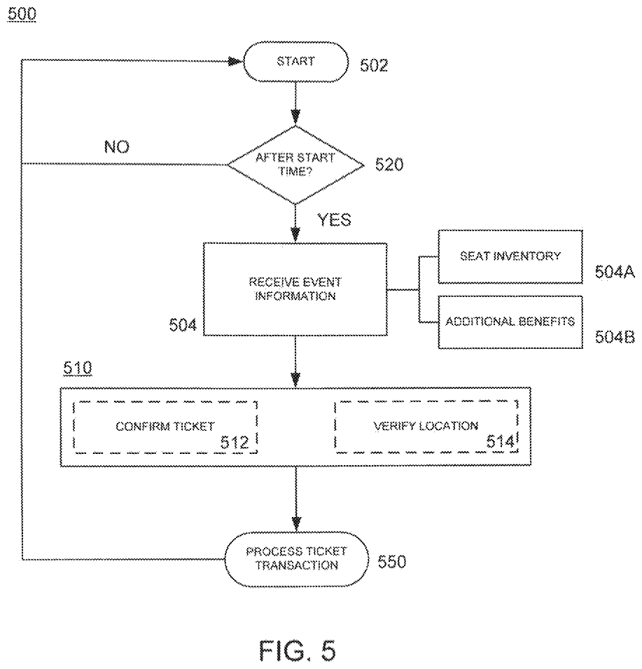

Referring now to FIG. 5, a flow diagram including exemplary method steps that may take place during event venue electronic ticket processing 500 according to additional venue management aspects of the disclosure is shown. Beginning at 502, the venue administrator may confirm that the request is taking place after the start time of the event 520. At 504 event confirmation, which may include seat inventory 504A, for example, unsold available seats, and/or additional benefits 504B, for example, restricted access available spots or prices, may be transmitted to the user for selection. At 510, one or both of the user's ticket admission 512 and location of the user 514 may be confirmed. In accordance with some aspects, by confirming an existing ticket admission 512, for example, a ticket purchased pre-event to access the venue, the selection provided to the user may be according to an upgrade or sell ticket preference. At 550, the user may obtain an electronic ticket upgrade or change that occurs post event start time and may come from the venue's unsold inventory or “no-shows” after admission to the venue has closed.

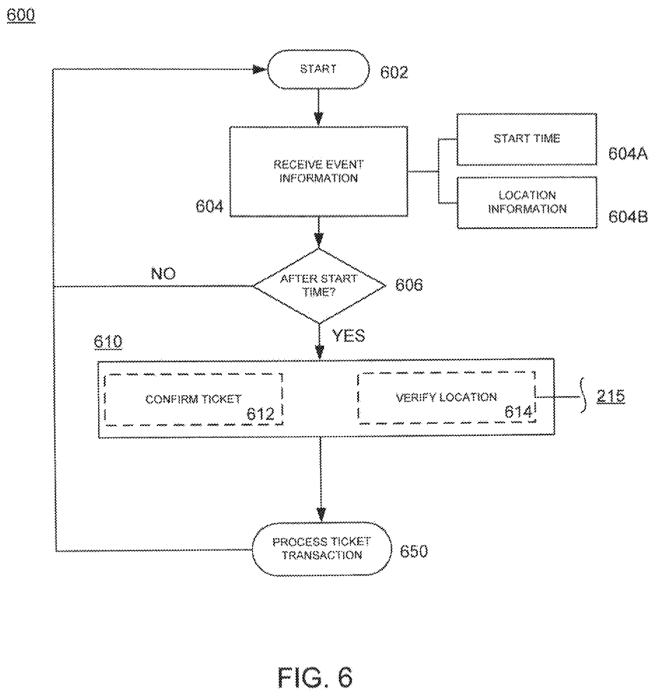

FIG. 6 is a flow diagram including exemplary method steps that may take place during event venue electronic ticket processing according to additional peer-to-peer ticket exchange aspects 600 of the disclosure is shown. Beginning at 602, the App or website may be prompted to receive event information at 604. Event information may include the event's start time 604A and location information 604B. Because of the peer-to-peer nature of the transaction, location information 604B may include data information about the venue, the buyer and multiple seller users that may be available. Location information may be event location but also includes a dynamic acceptable range that may be used to determine an acceptable location for the electronic ticket buyer using the App. At 606, a determination that the request has been made after start time of an event takes place for the system to then process data 610 relating to one or both an existing ticket 612 and a user's location 614. Aspects of the processing/verification may take place as described in reference to 215. After the information is transmitted, the management system may process the ticket transaction at 650.

In another embodiment, the method of the electronic ticket processing system may enable processing multiple sales of the same seat during a single event. This method enables the venue to maximize revenue by selling a single seat to multiple buyers for different portions of the event. For example, if a seat remains unoccupied during the first half of a sporting event or if the seat attendee leaves the game after the first half, the venue may resell that seat to another attendee for the second half. The seat may be resold anytime the current seat attendee leaves the event. This resale will ensure that high demand seats remain occupied and allow an additional revenue source for the venue taken from transactional based fees or from a portion of the ticket sale/resale. Furthermore, additional opportunities for charity donations may be given as a percentage of the sale or resale of the seller's ticket that the seller or the venue assigned as options for that specific event. The sale of the same seat may follow any of the flow discussed above in FIGS. 2, 4-6 for each repeated sale.

When a previously purchased ticket is being resold, a new set of conditions must be verified so that no errors in the transactions occur and that there is no overlap between ticket holders after the transaction. To achieve this verification, the system may incorporate a series of condition checks. For example, before finalizing the transaction or during initialization of the transaction, the system can verify the seller's location to ensure that the seller has, either, left the venue or purchased another seat within the event.

In an exemplary scenario, when a previously purchased ticket is being resold, the system may perform a location check to determine if the seller is anywhere in the venue. If the seller is still within the venue, the system may check transaction logs to determine if said seller has purchased a different seat. If the system discovers that the seller is still in the venue and has not purchased a second seat then the system may provide an alert to the user (e.g., a pop-up message on a mobile app) informing the seller that the transaction can only be finalized once they leave the venue or has purchased a second seat. If the system confirms that the seller has purchased a second seat, then the transaction between the parties will proceed to completing.

In another embodiment, the electronic ticket processing system may allow, after a during-event transaction is completed, the buyer the ability to use their newly transferred electronic ticket as a key to unlock and access enhanced products, services and experiences that were previously unavailable to the buyer before their during-event transaction was completed. The buyer may benefit from one or more improved experiences including, but not limited to: an upgraded seat location; special promotions; special access to and/or discounts on merchandise, food and beverage, parking; access to areas of the venue where they can meet and greet VIP guests such as athletes, musicians, actors, politicians, other forms of celebrities, etc. These added benefits not only create a sense of exclusivity and value for the buyer but also incentivize the purchase of resold tickets, contributing to increased demand and overall revenue generation. This system presents an opportunity for the venue to generate additional revenue by offering seat upgrade services and corresponding amenities that attendees can choose to purchase, thereby creating an additional source of fees and revenue for the venue.

In the system and method of the present disclosure, a variety of “user interfaces” may be utilized to allow a user to interface with the processing machine or machines that are used to implement the present disclosure. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

That said, in FIGS. 7A-7L, exemplary user interface displays for the peer-to-peer during event ticket purchase in accordance with aspects of the disclosure are illustrated. Beginning with FIG. 7A, a user may receive promotional messages about the App. and be prompted to allow the App. to access his/her location or enter the event's location. At FIG. 7B, the App. will confirm the location found/entered and provide event information for user's confirmation. After location and event information is transmitted by the user's device, the App. user is afforded the opportunity to buy or sell his/her electronic ticket 7C. As shown in FIG. 7D, the ticket information may be transmitted by scanning the ticket or by entering seat information. At FIG. 7E, from the beginning and ending time confirmation, the system displays the ticket information and event's remaining time. In some embodiments, as displayed in FIG. 7F, the user may be presented with a suggested price to sell his/her ticket to a user wanting to change his event experience. As previously disclosed, the suggested value for the seat exchange may be determined using the event's remaining time for the event using the beginning and ending time data may be determined. In addition, the determination may also include a live event update that is received in real time, such as, weather data, a broadcasting camera's location, an event's feedback or score, attendance data, crowd distribution, safety or evacuation procedures, and a news update or any other geosocial phenomena.

At FIG. 7G, the user may be provided to select a charity to donate all or a portion of the sale's price for his/her ticket and, at FIG. 7H, the listing price for the partial duration electronic ticket may be set by the user. As shown in FIG. 7H, the App. may provide the user with notification preferences. Notifications may include, for example, that the ticket sold as shown in FIG. 7J, or that additional seats have been released for the seller to buy, restricted access notifications, offers, and the like.

Referring now to FIGS. 8A-8H, exemplary user interface displays for the peer-to-peer during event ticket purchase in accordance with aspects of the disclosure are illustrated. Beginning at FIG. 8A, a user may receive promotional messages about the App. and be prompted to allow the App. to access his/her location or enter the event's location. As shown in FIG. 8A, if no events are found within the dynamic acceptable range, the App will notify the user that the App is not available until after start time of the event. As shown in FIG.*C, after the event has started, the App. may allow a ticketholder or a user within the dynamic acceptable range to view seats, charities, and offers offered by the App. At FIG. 8D, offered seats from other attendees or unsold seats may be offered to the buyer user for purchase for an opportunity to enhance his/her experience. At FIG. 8E, a sample SMS notification, in accordance with previously stored user preferences, is shown. This notification may direct the user to the App. to view details about the available ticket as shown in FIG. 8F. The peer-to-peer during event ticket purchase may also allow buyers to make an offer on tickets for sale. The make an offer feature provides buyers with the opportunity to suggest a price that they are willing to pay for a ticket, even if the current asking price is too high. The ticket sellers may then choose to accept, reject, or counter the offer. The peer-to-peer during event ticket purchase may also provide a communication platform for the buyer and seller to negotiate in real time. The system may allow buyers and sellers to communicate with each other directly, utilizing a chat function or other communication method (e.g. video chat) within the platform via the wireless devices. The communication platform allows buyers and sellers to potentially achieve an agreed price more rapidly. This feature also enhances the overall user experience on the platform, providing users with a more personal and immediate negotiation experience.

The peer-to-peer during even ticket purchase may also include a system where confirmation of the completed transaction is transmitted to the mobile device of both the buyer and seller in case there is a dispute. Both the buyer and seller will have confirmation of the transaction on their mobile phone and may show it to venue authorities if a dispute occurs.

The peer-to-peer during even ticket purchase may also allow, where if at the start of the peer-to-peer during event ticket purchase the buyer and seller both held tickets to the event and where a transaction is completed, the system will prompt the buyer of the ticket to place their original ticket up for sale on the platform and immediately suggest a price guided by an algorithm.

Additional features of the auction-based, during event, peer-to-peer electronic ticket exchanges may include an AI-powered dynamic pricing suggestion system for the seller. In some embodiments, the system uses machine learning algorithms to analyze data such as historical ticket sales, market trends, and user behavior to suggest an optimal ticket price for sellers. The AI pricing suggestion system may take into account data associated with the current game such as the location, date, and time of the event, as well as the demand and supply of tickets. This smart dynamic pricing allows seller to have more confidence in pricing their tickets competitively, while buyers may benefit from more consistent pricing while further enhancing the fairness and competitiveness of the peer-to-peer ticket sales platform.

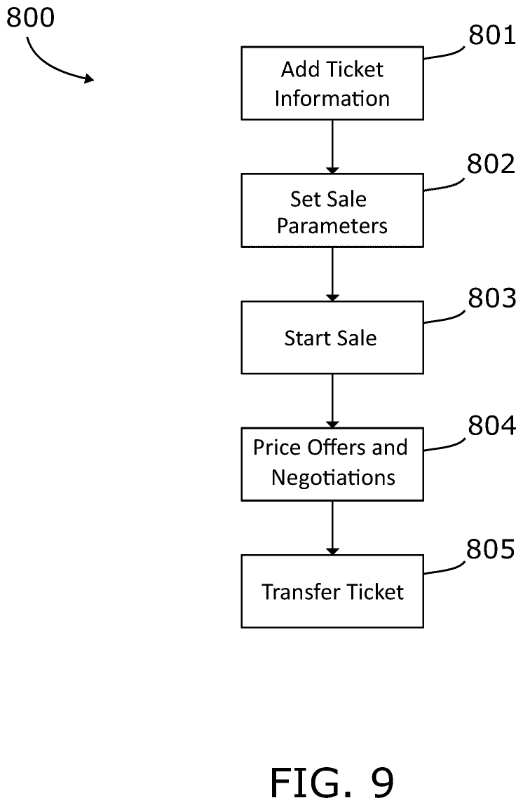

FIG. 9 shows an exemplary flowchart of the peer-to-peer during even ticket selling process 800. At step 801, the peer-to-peer selling platform may verify the ticket holder's information to ensure that the seller is indeed the legitimate owner of the ticket, thereby preventing fraudulent transactions. At step 802 the sale parameter is set as desired by the seller. The parameters may include data such as sale price, seat number, pictures of the seat, and view from the seat. The peer-to-peer selling platform may suggest a sale price based on different factors such as the amount of time remaining of an event, the weather, the current game score, the team season record currently playing, event type, and other factors that may alter the event demand. The price may also be suggested using AI. At step 802, the seller may choose to allocate a percentage of the sale proceeds to a charitable organization of their choice. At step 803 the ticket will be posted on the platform for sale and the selling process begins. At step 804 the platform allows potential buyers to purchase the ticket for the listed price or provide an offer to the seller. At this step 804, the potential buyers may also provide offers to the seller of a price lower than the listed price of the ticket. Alternative or additional negotiations may occur by utilizing direction communication feature between the potential buyer and the seller. The potential buyer and seller may be able to text, call, or video chat to negotiate pricing of the ticket. Once the seller has accepted an offer by the potential buyer, the ticket will be transferred to the buyer at 805.

The present system may also provide an auctioning system that allows sellers to auction off their tickets to the highest bidder. The auctioning system provides an alternative to dynamic pricing described above and allows sellers to potentially earn more money from their tickets. Buyers may bid on tickets and compete against each other to secure the tickets they desire, while sellers may benefit from the potential for higher prices. The duration of the auction of the tickets may be predetermined by the seller. The computing device may host the auction system and process the auction data associated with the auction system and communicate auction data with the wireless devices of the attendees. Auction data may include different auction variables such as the current bid, duration left for auction, starting bid, reserve price, and seat information. The auction process may be integrated into the steps described above. The auction process may be integrated and occur within, for example, step 225/450/550/650 as described above.

The auctioning system allows sellers to set a minimum price for their tickets, which serves as the starting bid for the auction. The auctioning system allows buyers to bid on the tickets in real-time, and once a predetermined time has passed or when a buyer has placed a winning bid, the auction terminates. In one embodiment, the auction system may also include anti-sniping measures to prevent last-minute bidding and to ensure a fair and competitive auction. In another embodiment, the auctioning system may include allowing the seller to set a reserve price. Reserve pricing may provide sellers the option to set a minimum price for their tickets by ensuring that they will not sell for less than a certain amount. This allows the sellers have more control over their ticket sales and allow a more comfortable selling experience.

The auctioning system may also provide the sellers opportunity to provide a picture of the current seat view as part of the auctioning process. The auctioning system allows sellers to upload a picture of the current seat view when selling the tickets. This picture upload feature allows buyers to get a better understanding of what the view will be like from their potential seats. This may help to increase buyer confidence in the purchase and potentially lead to better sales price for the seller.

The peer-to-peer transaction and auctioning system's increased flexibility for selling tickets, as described above, may result in higher revenue for the venue by offering additional options to ticket holders and attendees.

In some embodiments, the seller of the ticket may be located outside the venue for instances where the ticket seller may not be able to attend the event. In this embodiment, the location of the seller may be outside of the geofenced location.

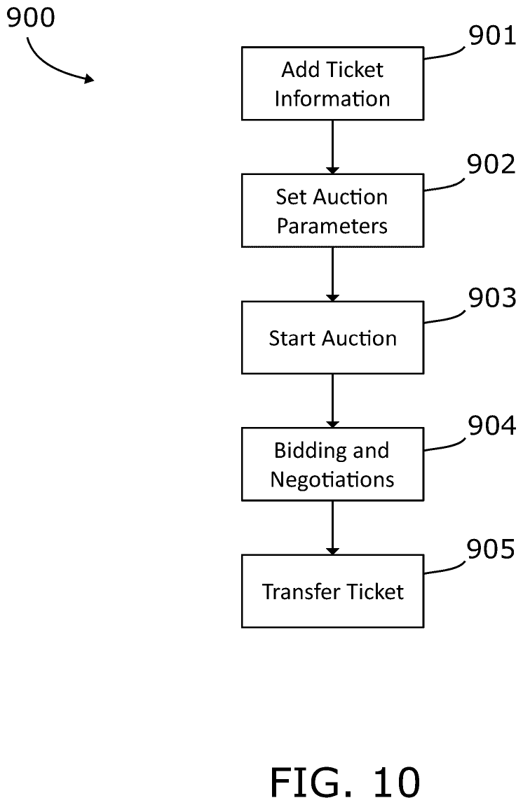

FIG. 10 shows an exemplary flowchart of the auctioning system 900. At step 901, the seller of the ticket will input ticket information data such as ticket holder information and seat number. At this step 901, the auction system may verify the ticket holder's information to ensure that the seller is indeed the legitimate owner of the ticket, thereby preventing fraudulent transactions. At step 902 the auction parameters may be set by the seller. The auction parameters may include minimum bid or minimum price, and auction duration. At this step 902, the seller may also provide a picture of the current seat and view from the seat and also the seller may choose to allocate a percentage of the sale proceeds to a charitable organization of their choice. Once the auction starts at step 903, buyers may provide bids or offers to the ticket seller at step 904. The ticket seller and potential buyers may also directly communicate using the auction system platform as described above. Once an offer has been accepted, or when duration of the auction is finished, the ticket may be sold and transferred at step 905 to the highest bidder or to the buyer who provided the accepted offer.

In another embodiment, the venue may be the seller. In this embodiment the peer to peer selling platform may provide a system and method for facilitating the sale of unsold tickets by event venues (e.g. in 210A). The electronic ticket exchange system enables venues to list and resell their unsold tickets directly to interested buyers. The venue may sell all, or a portion, of the unsold ticket inventory to either existing ticket holder(s) at the event or non-ticket holder(s) within a predetermined geofenced location. The holder (e.g. the venue) may want to strategically manage their unsold ticket inventory to create the perception of a sold-out event, particularly in sections that are prominently displayed on television broadcasts. By filling out these seats, the venue may generate additional demand and excitement to future events by providing the impression that the venue is packed. These unsold seats may also be provided to users who are within a predetermined geo-fenced area and within proximity to the venue. These unsold tickets may also be sold using the auction system as discussed above and handled via the venue computing device 122 and/or controller 300 holding the seat inventory 504a.

As previously discussed above, these unsold seats may provide the opportunity of the buyer to access new discounts or promotions that may be associated to that unsold seat, to enhance the future ticket holder's experience such as special access to and/or discounts on merchandise, food and beverage, parking; access to areas of the venue where they may meet and greet VIP guests such as athletes, musicians, actors, politicians, other forms of celebrities, etc. The level of discounts and types of promotions may be dynamically suggested an algorithm that takes into account the amount of time remaining of an event, the weather, the current game score, the team season record (e.g., standing) currently playing, event type (e.g., playoff game, elimination game), and other factors that may alter the event demand (e.g. a game that is a player's retirement game). The benefits associated with the ticket and/or seat may be stored in 504B handled by the venue computing device 122 and/or controller 300.

In accordance with aspects of the disclosure, as described above and as further defined by the claims below, by enabling during event, peer-to-peer, location based seat or access exchanges, a user may upgrade his/her experience according to his/her own preferences, while allowing the venue to increase its revenue and manage seating in accordance with preferences, broadcasting, safety, crowd control, and the like.

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as one skilled in the art would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law.

What is claimed is:

1. An electronic ticket processing system, for a peer-to-peer exchange of tickets to an event located at a venue, the system comprising:
a computing device having a processor, wherein the computing device is configured to communicate with a plurality of wireless devices, wherein a first one of the wireless devices is controlled by a first event attendee in possession of a ticket to a first seat and desiring to obtain a new ticket to a second seat after the beginning time of an event;
wherein the first attendee engages in a peer-to-peer transaction with the computing device including the electronic exchange of the ticket to the second seat during the event;
wherein the computing device is configured to communicate with the venue's seat inventory system; and
executable software code executed by the processor of the computing device for processing the peer-to-peer transaction of the electronic exchange of the ticket to the second seat, wherein the peer-to-peer transaction for the electronic exchange of the ticket to the second seat comprises:
identifying the one or more pre-determined network associated with the venue, wherein each pre-determined network has a defined network range;
a verification process that includes determining that a location of the plurality of wireless devices is within the defined network range of the one or more pre-determined network and is connected to the one or more pre-determined network at a time of the peer-to-peer transaction of the electronic exchange of the ticket to the second seat is processed by measuring a corresponding signal strength of the one or more pre-determined network connected to each of the wireless devices; and
the computing device initiates the offer of the ticket to the new second seat to at least the first event attendee at a suggested price depending on event variables and the ticket to the new second seat is transferred to the first event attendee wherein the timing initiation of the offer of the ticket to the new seat depends on the location of the seat within the venue's seat inventory system and the time elapsed after the beginning time of the event.

2. The system of claim 1, wherein the new ticket is an unsold tickets after the beginning time of an event.

3. The system of claim 1, wherein the event variables includes at least one of an amount of time remaining of the event, current weather, current game score, team season record currently playing, and event type.

4. The system of claim 1, wherein the computing device also initiates an auction-based process, wherein the first event attendee receives the ticket to the new second seat after winning the auction-based exchange.

5. An electronic ticket processing system, for a peer-to-peer exchange of tickets to an event located at a venue, the system comprising:
a computing device having a processor, wherein the computing device is configured to communicate with a plurality of wireless devices, wherein a first one of the wireless devices is controlled by a first event attendee in possession of a ticket to a first seat and desiring to obtain a new ticket to a second seat after the beginning time of an event;
wherein the first attendee engages in a peer-to-peer transaction with the computing device including the electronic exchange of the ticket to the second seat during the event;
wherein the computing device is configured to communicate with the venue's seat inventory system; and
executable software code executed by the processor of the computing device for processing the peer-to-peer transaction of the electronic exchange of the ticket to the second seat, wherein the peer-to-peer transaction for the electronic exchange of the ticket to the second seat comprises:
identifying the one or more coordinates associated with the venue;
a verification process that includes confirming that a location of the plurality of wireless devices is within the one or more coordinates associated with the venue and is communicating with the computing device at a time of the peer-to-peer transaction of the electronic exchange of the new ticket to the new seat is processed by analyzing, via corresponding wireless devices, an absolute time of reception of the GPS signals from a plurality of satellites to the corresponding wireless devices, and calculating the absolute position of the corresponding wireless devices depending on the absolute time of reception of each GPS signal from corresponding satellites of the plurality of satellites, and comparing the absolute position of the corresponding wireless devices to the one or more coordinates associated with the venue;
the computing device initiates the offer of the ticket to the new second seat to at least the first event attendee via the first one of the wireless devices the ticket to the new second seat is transferred to the first event attendee wherein the timing initiation of the offer of the ticket to the new seat depends on the location of the seat within the venue's seat inventory system and the time elapsed after the beginning time of the event.

6. The system of claim 5, wherein the new ticket is an unsold tickets after the beginning time of an event.

7. The system of claim 4, wherein the auction-based exchange includes a starting price that is dependent on at least one of an amount of time remaining of the event, current weather, current game score, team season record currently playing, and event type.

8. The system of claim 5, wherein the computing device also initiates an auction-based process, wherein the first event attendee receives the ticket to the new second seat after winning the auction-based exchange.

9. An electronic ticket processing system, for a peer-to-peer exchange of tickets to an event located at a venue, the system comprising:
a computing device having a processor, wherein the computing device is configured to communicate with a plurality of wireless devices, wherein a first one of the wireless devices is controlled by a first event attendee in possession of a ticket to a first seat and desiring to obtain a ticket to a second seat after the beginning time of an event;
wherein the first attendee engages in a peer-to-peer transaction with the computing device including the electronic exchange of the ticket to the second seat during the event;
wherein the computing device is configured to communicate with the venue's seat inventory system; and
executable software code executed by the processor of the computing device for processing the peer-to-peer transaction of the electronic exchange of the ticket to the second seat, wherein the peer-to-peer transaction for the electronic exchange of the ticket to the second seat comprises:
identifying the one or more pre-determined network associated with the venue, wherein each pre-determined network has a defined network range;
a verification process that includes determining that a location of the plurality of wireless devices is within the defined network range of the one or more pre-determined network and is connected to the one or more pre-determined network at a time of the peer-to-peer transaction of the electronic exchange of the ticket to the second seat is processed by measuring a corresponding signal strength of the one or more pre-determined network connected to each of the wireless devices; and
the computing device initiates the offer of the ticket to the second seat to at least the first event attendee at a suggested price depending on at least one of a plurality of event variables and the ticket to the second seat is transferred to the first event attendee wherein the initiation of the offer of the ticket to the second seat depends on at least one of the plurality of event variables.

10. The system of claim 9, wherein each new ticket corresponding to a new seat are unsold tickets after the beginning time of an event.

11. The system of claim 9, wherein each new ticket is listed at a suggested price depending on event variables, wherein the event variables includes at least one of an amount of time remaining of the event, current weather, current game score, team season record currently playing, and event type.

12. The system of claim 9, wherein the computing device also initiates an auction-based process, wherein the first event attendee receives the ticket to the new second seat after winning the auction-based exchange.

13. The system of claim 9, wherein the suggested price and the initiation of the offer are based on the same at least one of the plurality of event variables.
